(19) United States
(12) Patent Application Publication
(10) Pub. No.: US 2026/0361544 A1
(43) Pub. Date: Nov. 12, 2026

(54) INFORMATION UPDATING DEVICE AND METHOD, AND AUTHENTICATION DEVICE

(71) Applicant: NEC Corporation, Tokyo (JP)

(72) Inventors: Yuta SHIMIZU, Tokyo (JP); Toshiyuki ISSHIKI, Tokyo (JP); Kengo MORI, Tokyo (JP); Kazuki INAGAKI, Tokyo (JP); Koyo SHIBATA, Tokyo (JP); Kohei HIJIKATA, Tokyo (JP)

(73) Assignee: NEC Corporation, Tokyo (JP)

(21) Appl. No.: 19/153,633

(22) PCT Filed: Feb. 17, 2023
(86) PCT No.: PCT/JP2023/005740

§ 371 Date: Aug. 5, 2025

(51) Int. Cl. H04L 9/32; G06F 21/32; H04L 9/08

(52) U.S. Cl. CPC H04L 9/3231; H04L 9/0891; G06F 21/32

(57) ABSTRACT

A biometric information acquisition unit acquires biometric information of a user. An encryption unit encrypts the acquired biometric information with cryptographic key information, and generates query biometric information. An authentication unit authenticates the user by comparing the generated query biometric information and target biometric information encrypted using the cryptographic key information. A sensing unit senses a prescribed operation of a device associated with authentication of the user. An information update unit updates the cryptographic key information and the target biometric information if the prescribed operation has been sensed.

### TECHNICAL FIELD

The present disclosure relates to an information updating device, an information updating method, an authentication device, an authentication method, and a computer-readable medium.

### BACKGROUND ART

As a related art, PTL 1 discloses a face authentication device. In PTL 1, biometric information about a user is encrypted by homomorphic encryption using a public key of the user. The authentication device receives encrypted biometric information, identification information about the user, and a public key of the user from an encryption device. The authentication device searches database and acquires the encrypted biometric information about the user and the public key of the user registered in the database. The authentication device authenticates the user based on the encrypted biometric information and the public key of the user acquired from the database, and the encrypted biometric information and the public key of the user received from the encryption device.

In PTL 1, in a case where the biometric information registered in the database leaks, biometric information re-registration processing is performed. In this case, the encryption device generates a new secret key and public key pair. The encryption device encrypts the biometric information about the user using the newly generated public key. The authentication device receives the newly generated public key and the encrypted biometric information from the encryption device. The authentication device updates the information registered in the database with the received public key and the received encrypted biometric information. In this way, even when the encrypted biometric information is leaked, it is possible to cancel the old encrypted biometric information and prevent impersonation using the leaked encrypted biometric information.

### CITATION LIST

### Patent Literature

PTL 1: JP 2011-211593 A

### SUMMARY OF INVENTION

### Technical Problem

In a case where encrypted biometric information is leaked, the authentication device disclosed in PTL 1 invalidates biometric authentication using the leaked biometric information by updating a key pair. However, in general, the user cannot know when the encrypted biometric information has leaked. During a period from when the user notices the leakage until the key pair is updated afterwards, the leaked encrypted biometric information is valid, and impersonation using the leaked encrypted biometric information is possible. Therefore, it is considered that the key information may be changed at an appropriate timing, not after the user notices that the key information has been leaked.

In view of the above circumstances, an object of the present disclosure is to provide an information updating device, an information updating method, an authentication device, an authentication method, and a computer-readable medium capable of updating key information used for encryption at an appropriate timing.

### Solution to Problem

In order to achieve the above object, the present disclosure provides, as a first aspect, an information updating device. An information updating device includes a detection unit that detects a predetermined operation of a device associated with authentication performed using encrypted biometric information about a user, and an information update unit that updates, in a case where the predetermined operation is detected, encryption key information used to encrypt the biometric information about the user and target biometric information encrypted with the encryption key information.

The present disclosure provides, as a second aspect, an authentication device. An authentication device includes a biometric information acquisition unit that acquires biometric information about a user, an encryption unit that encrypts the acquired biometric information with encryption key information to generate query biometric information, an authentication unit that authenticates the user by verifying the query biometric information against target biometric information encrypted using the encryption key information, a detection unit that detects a predetermined operation of a device associated with the authentication, and an information update unit that updates the encryption key information and updates the target biometric information using the updated encryption key information in a case where the predetermined operation is detected.

The present disclosure provides, as a third aspect, an information updating method. An information updating method including detecting a predetermined operation of a device associated with authentication performed using encrypted biometric information about a user, and updating, in a case where the predetermined operation is detected, encryption key information used to encrypt the biometric information about the user and target biometric information encrypted with the encryption key information.

The present disclosure provides, as a fourth aspect, an authentication method. An authentication method includes acquiring biometric information about a user, encrypting the acquired biometric information with encryption key information to generate query biometric information, authenticating the user by verifying the query biometric information against target biometric information encrypted using the encryption key information, detecting a predetermined operation of a device associated with the authentication, and updating the encryption key information and updates the target biometric information using the updated encryption key information in a case where the predetermined operation is detected.

As a fifth aspect, the present disclosure provides a computer-readable medium. A computer-readable medium storing a program for causing a processor to execute processing of detecting a predetermined operation of a device associated with authentication performed using encrypted biometric information about a user, and updating, in a case where the predetermined operation is detected, encryption key information used to encrypt the biometric information about the user and target biometric information encrypted with the encryption key information.

The present disclosure provides a computer-readable medium as a sixth aspect. A computer-readable medium storing a program for causing a processor to execute processing of acquiring biometric information about a user, encrypting the acquired biometric information with encryption key information to generate query biometric information, authenticating the user by verifying the query biometric information against target biometric information encrypted using the encryption key information, detecting a predetermined operation of a device associated with the authentication, and updating the encryption key information and updates the target biometric information using the updated encryption key information in a case where the predetermined operation is detected.

### Advantageous Effects of Invention

The information updating device, the information updating method, the authentication device, the authentication method, and the computer readable medium according to the present disclosure can update key information used for encryption at an appropriate timing.

### BRIEF DESCRIPTION OF DRAWINGS

FIG. 1 is a block diagram illustrating a schematic configuration of an authentication device according to the present disclosure.

FIG. 2 is a block diagram illustrating an authentication system including an authentication device according to one example embodiment of the present disclosure.

FIG. 3 is a schematic diagram illustrating biometric information, query biometric information, and target biometric information extracted from a camera image.

FIG. 4 is a flowchart showing an operation procedure at the time of authentication in the authentication device.

FIG. 5 is a flowchart illustrating an operation procedure of the authentication device at the time of key information update.

FIG. 6 is a block diagram illustrating a configuration example of an electronic device.

### EXAMPLE EMBODIMENT

Prior to describing example embodiments of the present disclosure, an overview of the present disclosure will be given. FIG. 1 illustrates a schematic configuration of an authentication device according to the present disclosure. The authentication device 10 includes a biometric information acquisition unit 11, an encryption unit 12, an authentication unit 13, a detection unit 15, and an information update unit 16. In the authentication device 10, the detection unit 15 and the information update unit 16 configure an information updating device 20.

FIG. 1 illustrates an example in which the information updating device 20 is included in the authentication device 10, but the present disclosure is not limited thereto. The information updating device 20 is not necessarily included in the authentication device 10, and the authentication device 10 and the information updating device 20 may be configured as independent devices.

The biometric information acquisition unit 11 acquires biometric information about the user. The encryption unit 12 encrypts the biometric information acquired by the biometric information acquisition unit 11 with the encryption key information to generate query biometric information. The authentication unit 13 authenticates the user by verifying the query biometric information against target biometric information encrypted using the encryption key information used by the encryption unit 12.

The detection unit 15 detects a predetermined operation of the device associated with authentication. Here, the device associated with authentication means, for example, a device operated by the user after authentication. For example, if the authentication is performed with respect to entering a predetermined location or area, the device associated with the authentication may be a device located at the predetermined location. In a case where a predetermined operation is detected, the information update unit 16 updates encryption key information used for encryption by the encryption unit 12. In addition, the information update unit 16 updates the target biometric information using the updated encryption key information.

In the present disclosure, the information update unit 16 updates the encryption key information and the target biometric information in a case where a predetermined operation of the device associated with authentication is detected. Even in a case where the target biometric information is stolen by a malicious person and the user is not aware of the stealing of the target biometric information, the encryption key information is updated in a case where a predetermined operation is detected. In the present disclosure, since the encryption key information and the target biometric information are updated in association with the predetermined operation in the device associated with authentication, the key information and the target biometric information used for encryption can be updated at an appropriate timing. Furthermore, in the present disclosure, a security risk can be reduced by updating the key information and the target biometric information used for encryption at an appropriate timing.

Hereinafter, the example embodiment of the present disclosure will be described in detail with reference to the drawings. The following description and drawings will be omitted or simplified as appropriate to clarify description. In each of the drawings described below, the same elements and similar elements are denoted by the same reference signs, and a duplicate description is omitted as necessary.

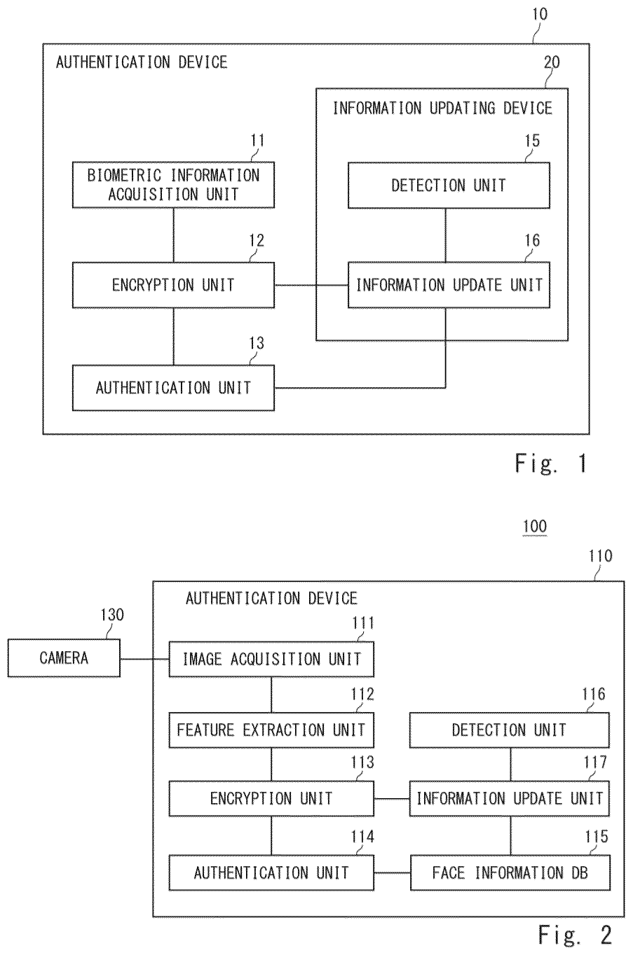

FIG. 2 illustrates an authentication system including an authentication device according to one example embodiment of the present disclosure. An authentication system 100 has an authentication device 110 and a camera 130. In the following description, an example in which the authentication system 100 is used for a vehicle interior entry in a vehicle such as an automobile will be described. The authentication system 100 is not limited to the vehicle interior entry, and may be applied to authentication in various systems such as an access management system to a specific location or area.

The camera 130 captures an image of a user to be authenticated or a subject. In the present example embodiment, the camera 130 captures an image of a person who is trying to get on the vehicle. The vehicle is a moving object such as a passenger car, a taxi, or a van. The camera 130 is mounted on a vehicle, for example, and captures an image of a user outside the vehicle from an inside of the vehicle. The camera 130 may be installed outside the vehicle and capture an image of a user approaching the vehicle. Alternatively, the camera 130 may be installed inside the vehicle and capture an image of the user in the vehicle. The authentication device 110 acquires an image of the user from the camera 130, and implements biometric authentication on the user using the acquired image.

Although only one camera 130 is illustrated in FIG. 2, the number of cameras 130 is not limited to one in the present example embodiment. The authentication system 100 may have a plurality of cameras 130. The authentication system 100 can include, for example, one or more cameras that capture an image of the vehicle from the outside of the vehicle, one or more cameras that are mounted on the vehicle and capture an image of a region outside the vehicle, and one or more cameras that are mounted on the vehicle and capture an image of an area inside the vehicle.

The authentication device 110 includes an image acquisition unit 111, a feature extraction unit 112, an encryption unit 113, an authentication unit 114, a face information database (DB) 115, a detection unit 116, and an information update unit 117. The authentication device 110 can be configured as, for example, a device including one or more memories and one or more processors. At least a part of the function of each unit in the authentication device 110 can be achieved by the processor operating according to a program read from the memory. The authentication device 110 may be mounted on a vehicle, for example. The authentication device 110 is associated with the authentication device 10 illustrated in FIG. 1.

The image acquisition unit 111 acquires a video or an image captured by the camera 130. The image acquisition unit 111 sequentially acquires the latest images captured by the camera 130. The feature extraction unit 112 extracts a biometric feature from the image acquired by the image acquisition unit 111. The biometric feature is also referred to as biometric information. For example, the feature extraction unit 112 detects a face region or a face image of a person existing around the vehicle, that is, the user from the image data, and extracts biometric information from the detected face region or face image. The feature extraction unit 112 is associated with the biometric information acquisition unit 11 illustrated in FIG. 1.

The encryption unit 113 encrypts the biometric information extracted by the feature extraction unit 112 using encryption key information to generate encrypted biometric information. In the present example embodiment, homomorphic encryption is used as an encryption scheme. The encrypted biometric information is also referred to as query biometric information. The encryption unit 113 corresponds to the encryption unit 12 illustrated in FIG. 1.

The face information DB 115 stores the biometric information extracted from the face image for each of one or more registrants to be authenticated, that is, each of the users. The face information DB 115 stores biometric information of each of a plurality of users in a storage such as a hard disk drive (HDD), a solid state drive (SSD), or a flash memory. The biometric information stored in the face information DB 115 is also referred to as target biometric information. In the present example embodiment, the target biometric information stored in the face information DB 115 is encrypted using encryption key information used for encryption by the encryption unit 113.

For example, the user registers the biometric information in the authentication device 110 in advance. In the case of registering the biometric information, the user inputs, for example, a camera image captured by his/her smartphone or digital camera to the authentication device 110. The authentication device 110 extracts the biometric information from the camera image input by the user in the feature extraction unit 112, and encrypts the biometric information extracted in the encryption unit 113 using the encryption key information. The authentication device 110 stores the encrypted biometric information in the face information DB 115 as the target biometric information. The face information DB 115 may store an encrypted face image of each of one or more users instead of or in addition to the encrypted biometric information.

In the present example embodiment, the face information DB 115 is not necessarily included in the authentication device 10. The face information DB 115 may be configured using, for example, a storage device connected to the authentication device 10 via a network.

The authentication unit 114 verifies the query biometric information encrypted by the feature extraction unit 112 with the target biometric information stored in the face information DB 115 to authenticate the user. More specifically, the authentication unit 114 acquires the target biometric information about each user from the face information DB 115. The authentication unit 114 verifies the query biometric information with the acquired target biometric information about each user. The authentication unit 114 calculates a verification score indicating a matching degree or a similarity degree between the query biometric information and the target biometric information. The verification score indicates a higher value as the matching degree or the similarity degree is higher, for example. For example, the authentication unit 114 compares the verification score calculated for each user with a threshold, and determines whether the face authentication is successful based on a result of the comparison. The authentication unit 114 is associated with the authentication unit 13 illustrated in FIG. 1.

The authentication result of the authentication device 110 is output to a device or system that uses the authentication result, such as a vehicle interior entry system. For example, the authentication device 110 outputs the authentication result to a vehicle equipment (not illustrated) such as an electronic control unit (ECU) that controls the vehicle through an in-vehicle network such as a controller area network (CAN). In a case where the person included in the camera image is authenticated as the user registered in advance, the ECU unlocks doors of the vehicle and permits the user to get on the vehicle. In a case where the person included in the camera image is not authenticated as the user registered in advance, the ECU does not unlock the doors of the vehicle.

The detection unit 116 detects a predetermined operation of the device associated with authentication. In the present example embodiment, the device associated with authentication is a vehicle, and the detection unit 116 detects a predetermined operation in the vehicle. The detection unit 116 detects, for example, at least one of opening and closing of a door of the vehicle, activation of a drive system such as an engine in the vehicle, starting of the vehicle, locking of the door of the vehicle, and stopping of the drive system. For example, the detection unit 116 may acquire a signal output from an ECU mounted on the vehicle through an in-vehicle network, and detect a predetermined operation in the vehicle based on the acquired signal. For example, the detection unit 116 may analyze an image of a camera that captures a region inside the vehicle or a region outside the vehicle, and detect a predetermined operation of the user in the vehicle. The detection unit 116 is associated with the detection unit 15 illustrated in FIG. 1.

In a case where a predetermined operation is detected in the detection unit 116, the information update unit 117 changes or updates the encryption key information used for generating the query biometric information in the encryption unit 113. Furthermore, the information update unit 117 updates the target biometric information stored in the face information DB 115 using the changed or updated encryption key information. The information update unit 117 may update the encryption key information and the target biometric information every time a predetermined operation is detected. Alternatively, the information update unit 117 may update the encryption key information and the target biometric information each time a predetermined operation is detected a predetermined number of times. The information update unit 117 is associated with the information update unit 16 illustrated in FIG. 1.

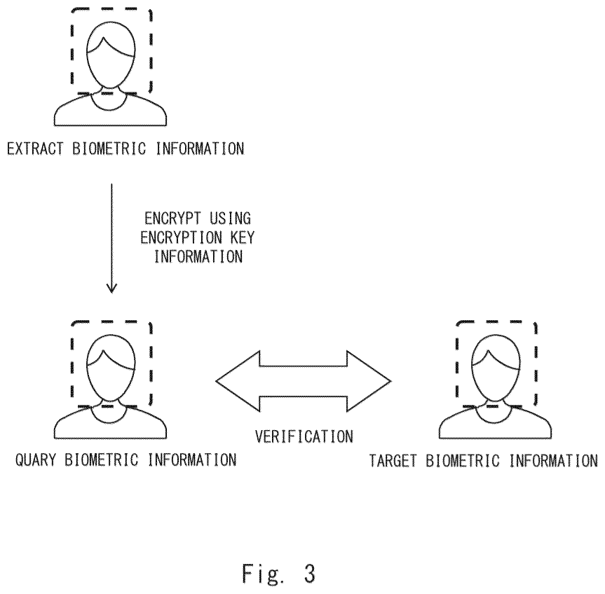

FIG. 3 illustrates the biometric information, the query biometric information, and the target biometric information extracted from the camera image. The feature extraction unit 112 extracts biometric information from the camera image. The encryption unit 113 encrypts the biometric information extracted by the feature extraction unit 112 using encryption key information to generate query biometric information. The authentication unit 114 verifies the query biometric information encrypted by the encryption unit 113 with the encrypted target biometric information stored in the face information DB 115.

In a case where the detection unit 116 detects a predetermined operation in the vehicle, the information update unit 117 updates the encryption key information and the target biometric information stored in the face information DB 115. In a case where the encryption key information is updated, the query biometric information and the target biometric information before the encryption key information is updated are different from the query biometric information and the target biometric information after the encryption key information is updated. Therefore, even if the target biometric information is stolen by a malicious person, the stolen target biometric information can be invalidated by changing the encryption key information. Therefore, the present example embodiment can reduce a risk in a case where personal information leaks and improve security.

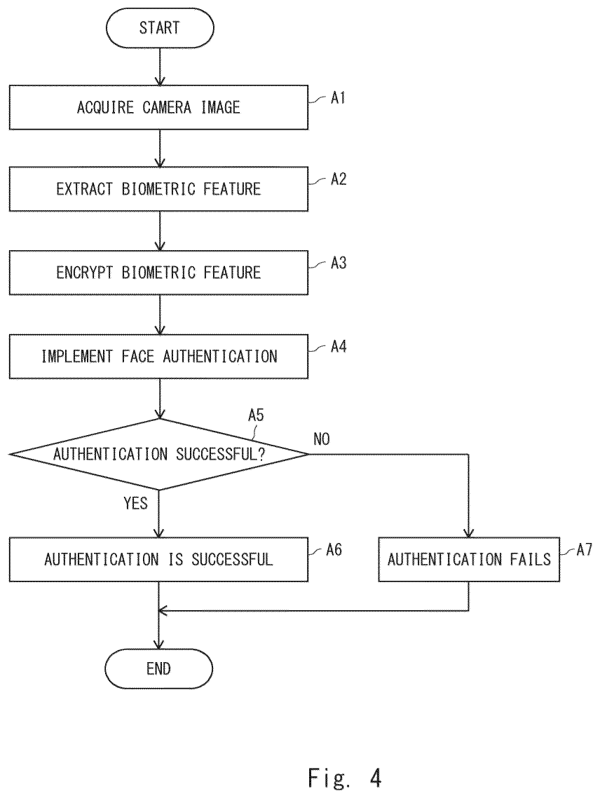

Next, an operation procedure will be described. FIG. 4 illustrates an operation procedure at the time of authentication in the authentication device 110. The operation procedure of the authentication device 110 is associated with an authentication method. The image acquisition unit 111 acquires a camera image from the camera 130 (step A1). The image acquisition unit 111 may periodically perform step A1 and acquire camera images in time series from the camera 130 that captures a moving image. The feature extraction unit 112 detects a face region from the camera image and extracts a biometric feature from the image of the face region (step A2). In step A2, for example, the feature extraction unit 112 extracts one or more feature points from the image of the face region, and extracts one or more biometric features based on the extracted one or more feature points.

The encryption unit 113 encrypts the biometric feature extracted in step A2 and generates query biometric information (step A3). The authentication unit 114 verifies the query biometric information generated in step A3 with the target biometric information stored in the face information DB 115, and implements face authentication (step A4). In step A4, for example, the authentication unit 114 calculates a verification score with the query biometric information for the target biometric information.

The authentication unit 114 determines whether the face authentication is successful (step A5). In step A5, for example, the authentication unit 114 compares the verification score with a threshold, and determines whether the face authentication is successful according to whether the verification score is equal to or more than the threshold. In a case where the verification score is equal to or more than the threshold, the authentication unit 114 determines that the face authentication is successful in step A5. In this case, the authentication unit 114 outputs a message indicating that the face authentication is successful to a device that uses the authentication result, such as the vehicle interior entry system (step A6).

In a case where the verification score is smaller than the threshold, the authentication unit 114 determines in step A5 that the face authentication has failed. In this case, the authentication unit 114 outputs a message indicating that the face authentication has failed to the device using the authentication result (step A7). In a case where the face authentication fails, the authentication device 110 may return to step A1 to redo the face authentication from the beginning.

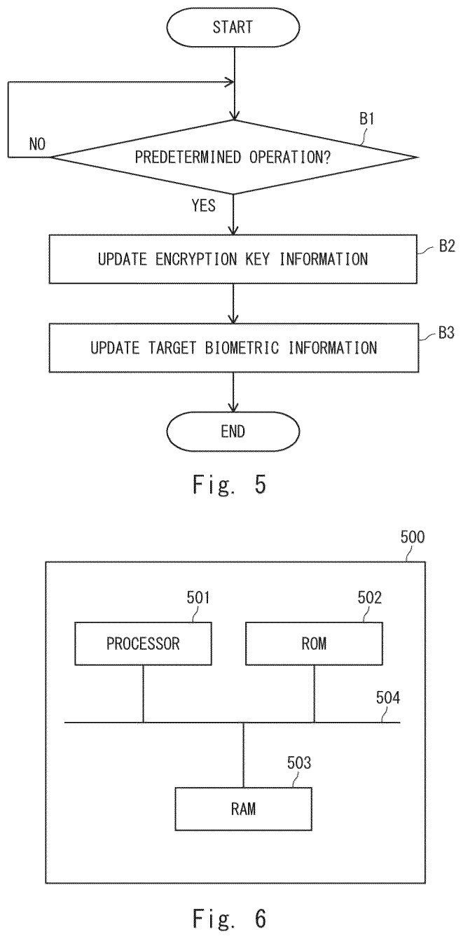

FIG. 5 illustrates an operation procedure of the authentication device 110 at the time of updating the key information. The operation procedure of the authentication device 110 at the time of key information update is associated with the information updating method. The operation procedure of the authentication device 110 at the time of key information update illustrated in FIG. 5 can be performed before or after the operation procedure of the authentication device 110 at the time of authentication illustrated in FIG. 4. Alternatively, the operation procedure of the authentication device 110 at the time of key information update illustrated in FIG. 5 can be performed in parallel with the operation procedure of the authentication device 110 at the time of authentication illustrated in FIG. 4.

The detection unit 116 determines whether a predetermined operation or manipulation is performed in the vehicle (step B1). In step B1, the detection unit 116 determines whether at least one of opening and closing of a door of the vehicle, activation of a drive system such as an engine in the vehicle, starting of the vehicle, locking of the door of the vehicle, and stopping of the drive system has been performed, for example.

In a case where it is determined that the predetermined operation or manipulation has been performed in the vehicle, the detection unit 116 transmits a notification indicating that the predetermined operation or manipulation has been detected to the information update unit 117. The detection unit 116 may count the number of times of execution of the predetermined operation or manipulation, and transmit a notification indicating that the predetermined operation or manipulation has been detected to the information update unit 117 in a case where the number of times reaches the predetermined number.

In a case where the notification indicating that the predetermined operation or manipulation has been detected is received from the detection unit 116, the information update unit 117 updates the encryption key information used for encrypting the biometric information in the encryption unit 113, that is, the encryption key information used for generating the query biometric information (step B2). In step B2, the information update unit 117 generates encryption key information different from the encryption key information used for encryption in the encryption unit 113, and transmits the generated encryption key information to the encryption unit 113. In a case where the encryption key information is received from the information update unit 117, the encryption unit 113 changes the encryption key information used for encryption to the encryption key information received from the information update unit 117.

Furthermore, the information update unit 117 updates the target biometric information stored in the face information DB 115 using the updated encryption key information (step B3). In step B3, the information update unit 117 updates the target biometric information by, for example, decrypting the target biometric information before update using the key information before update and encrypting the decrypted target biometric information using the updated encryption key information.

In the present example embodiment, the information update unit 117 updates the encryption key information and the target biometric information in a case where a predetermined operation is detected by the detection unit 116. In a case where the information update unit 117 updates the encryption key information, the target biometric information encrypted with the old encryption key information cannot be used for authentication. Therefore, the present example embodiment can improve security. In addition, in the present example embodiment, the encryption key information and the target biometric information are updated in a case where a predetermined operation is detected. Therefore, even if the user does not particularly instruct the update of the encryption key information, the encryption key information is periodically updated. In the present example embodiment, even if target biometric information is stolen, a period during which the stolen target biometric information can be used for authentication can be shortened, and a possibility that the stolen target biometric information is abused can be reduced.

Next, a hardware configuration of the authentication device 110 will be described. FIG. 6 illustrates an example of a hardware configuration of an electronic device that can be used in the authentication device 110. An electronic device 500 includes a processor (central processing unit (CPU)) 501, a read only memory (ROM) 502, and a random access memory (RAM) 503. In the electronic device 500, the processor 501, the ROM 502, and the RAM 503 are connected to each other via a bus 504. Although not illustrated, the authentication device 110 may include other circuits such as a peripheral circuit, a communication circuit, and an interface circuit.

The ROM 502 is a nonvolatile storage device. For example, a semiconductor storage device such as a flash memory having a relatively small capacity is used for the ROM 502. The ROM 502 stores a program executed by the processor 501.

The program described above includes a group of commands (or software codes) for causing a computer to perform one or more functions described in the example embodiments in a case where the program is read by the computer. The program may be stored in a non-transitory computer-readable medium or in a tangible storage medium. As an example and not by way of limitation, the computer-readable medium or the tangible storage medium includes a RAM, a ROM, a flash memory, an SSD or any other memory technology, a compact disc (CD), a digital versatile disc (DVD), a Blu-ray (registered trademark) disk or any other optical disk storage, a magnetic cassette, a magnetic tape, a magnetic disk storage or any other magnetic storage device. The program may be transmitted on a transitory computer-readable medium or a communications medium. As an example and not by way of limitation, a transitory computer-readable or communication medium includes electrical, optical, acoustic, or other forms of propagated signals.

The RAM 503 is a volatile storage device. As the RAM 503, various types of semiconductor memory devices such as a dynamic random access memory (DRAM) or a static random access memory (SRAM) are used. The RAM 503 can be used as an internal buffer for transitorily storing data and the like.

The processor 501 loads the program stored in the ROM 502 on the RAM 503, and executes the program. Functions of the respective units in the authentication device 110 can be achieved by the CPU 501 executing the program.

In the above example embodiment, the authentication device 110 is not necessarily configured as a single device. The authentication device 110 may be configured using a plurality of physically separated devices. For example, the authentication device 110 may be separated into a device including the image acquisition unit 111, the feature extraction unit 112, the encryption unit 113, and the authentication unit 114 and an information updating device including the detection unit 116 and the information update unit 117.

In addition, in a case where the authentication device 110 is used for the vehicle interior entry, the authentication device 110 does not necessarily have all the functions mounted on the vehicle. For example, a part of the functions of the authentication device 110 may be mounted on the vehicle, and the rest may be disposed outside the vehicle. Alternatively, each unit of the authentication device 110 may be disposed outside the vehicle. In that case, the authentication device 110 may acquire a camera image of the camera 130 via a wireless communication network. In addition, the authentication device 110 may transmit the authentication result to the vehicle via a wireless communication network.

Although the example embodiment according to the present disclosure has been described above in detail, the present disclosure is not limited to the above-described example embodiments, and the present disclosure also includes those that are obtained by making changes or modifications to the above-described example embodiments without departing from the scope of the present disclosure.

For example, some or all of the above-described example embodiment may be described as the following Supplementary Notes, but the present disclosure is not limited to the following Supplementary Notes.

### [Supplementary Note 1]

An information updating device including:
a detection unit that detects a predetermined operation of a device associated with authentication performed using encrypted biometric information about a user; and
an information update unit that updates, in a case where the predetermined operation is detected, encryption key information used to encrypt the biometric information about the user and target biometric information encrypted with the encryption key information.

### [Supplementary Note 2]

The information updating device according to Supplementary Note 1, in which the device associated with the authentication is a vehicle, and the detection unit detects a predetermined operation in the vehicle.

### [Supplementary Note 3]

The information updating device according to Supplementary Note 2, in which the detection unit detects at least one of opening/closing of a door of the vehicle, activation of a drive system in the vehicle, start of the vehicle, locking of a door of the vehicle, and stop of the drive system.

### [Supplementary Note 4]

The information updating device according to any one of Supplementary Notes 1 to 3, in which the information update unit updates the encryption key information and updates the target biometric information using the updated encryption key information in a case where the predetermined operation is detected a predetermined number of times.

### [Supplementary Note 5]

An authentication device including:
a biometric information acquisition unit that acquires biometric information about a user;
an encryption unit that encrypts the acquired biometric information with encryption key information to generate query biometric information;
an authentication unit that authenticates the user by verifying the query biometric information against target biometric information encrypted using the encryption key information;
a detection unit that detects a predetermined operation of a device associated with the authentication; and
an information update unit that updates the encryption key information and updates the target biometric information using the updated encryption key information in a case where the predetermined operation is detected.

### [Supplementary Note 6]

The authentication device according to Supplementary Note 5, in which
the authentication device is used in a vehicle, and
the device associated with the authentication is the vehicle, and the detection unit detects a predetermined operation in the vehicle.

### [Supplementary Note 7]

The authentication device according to Supplementary Note 6, in which the detection unit detects at least one of opening/closing of a door of the vehicle, activation of a drive system in the vehicle, start of the vehicle, locking of a door of the vehicle, and stop of the drive system.

### [Supplementary Note 8]

The authentication device according to Supplementary Note 6 or 7, in which the authentication device is used to authenticate the user in a vehicle interior entry of the vehicle.

### [Supplementary Note 9]

An information updating method including: detecting a predetermined operation of a device associated with authentication performed using encrypted biometric information about a user; and updating, in a case where the predetermined operation is detected, encryption key information used to encrypt the biometric information about the user and target biometric information encrypted with the encryption key information.

### [Supplementary Note 10]

An authentication method including:
acquiring biometric information about a user;
encrypting the acquired biometric information with encryption key information to generate query biometric information;
authenticating the user by verifying the query biometric information against target biometric information encrypted using the encryption key information;
detecting a predetermined operation of a device associated with the authentication; and
updating the encryption key information and updating the target biometric information using the updated encryption key information in a case where the predetermined operation is detected.

### [Supplementary Note 11]

A non-transitory computer-readable medium storing a program for causing a processor to execute processing of:
detecting a predetermined operation of a device associated with authentication performed using encrypted biometric information about a user; and
updating, in a case where the predetermined operation is detected, encryption key information used to encrypt the biometric information about the user and target biometric information encrypted with the encryption key information.

### [Supplementary Note 12]

A non-transitory computer-readable medium storing a program for causing a processor to execute processing of:
acquiring biometric information about a user;
encrypting the acquired biometric information with encryption key information to generate query biometric information;
authenticating the user by verifying the query biometric information against target biometric information encrypted using the encryption key information;
detecting a predetermined operation of a device associated with the authentication; and
updating the encryption key information and updates the target biometric information using the updated encryption key information in a case where the predetermined operation is detected.

### REFERENCE SIGNS LIST

10 authentication device
11 biometric information acquisition unit
12 encryption unit
13 authentication unit
15 detection unit
16 information update unit
20 information updating device
100 authentication system
110 authentication device
112 feature extraction unit
113 encryption unit
114 authentication unit
115 face information DB
116 detection unit
117 information update unit
130 camera
500 electronic device
501 processor
502 ROM
503 RAM
504 bus

What is claimed is:

1. An information updating device comprising:
at least one memory storing instructions; and
at least one processor configured to execute the instructions to:
detect predetermined operation of a device associated with authentication performed using encrypted biometric information about a user; and
update, in a case where the predetermined operation is detected, encryption key information used to encrypt the biometric information about the user and target biometric information encrypted with the encryption key information.

2. The information updating device according to claim 1, wherein
the device associated with the authentication is a vehicle, and
the at least one processor is configured to execute the instructions to detect predetermined operation in the vehicle.

3. The information updating device according to claim 2, wherein the at least one processor is configured to execute the instructions to detect least one of opening/closing of a door of the vehicle, activation of a drive system in the vehicle, start of the vehicle, locking of a door of the vehicle, and stop of the drive system.

4. The information updating device according to claim 1, wherein the at least one processor is configured to execute the instructions to update the encryption key information and updates the target biometric information using the updated encryption key information in a case where the predetermined operation is detected a predetermined number of times.

5. An authentication device comprising:
at least one memory storing instructions; and
at least one processor configured to execute the instructions to:
acquire biometric information about a user;
encrypt the acquired biometric information with encryption key information to generate query biometric information;
authenticate the user by verifying the query biometric information with target biometric information encrypted using the encryption key information;
detect a predetermined operation of a device associated with the authentication; and
update the encryption key information and update the target biometric information using the updated encryption key information in a case where the predetermined operation is detected.

6. The authentication device according to claim 5, wherein
the authentication device is used in a vehicle, and
the device associated with the authentication is the vehicle, and
the at least one processor is configured to execute the instructions to detect predetermined operation in the vehicle.

7. The authentication device according to claim 6, wherein the at least one processor is configured to execute the instructions to detect at least one of opening/closing of a door of the vehicle, activation of a drive system in the vehicle, start of the vehicle, locking of a door of the vehicle, or stop of the drive system.

8. The authentication device according to claim 6, wherein the authentication device is used to authenticate the user in a vehicle interior entry of the vehicle.

9. An information updating method comprising:
detecting a predetermined operation of a device associated with authentication performed using encrypted biometric information about a user; and
updating, in a case where the predetermined operation is detected, encryption key information used to encrypt the biometric information about the user and target biometric information encrypted with the encryption key information.

10-12. (canceled)
